(19) United States
(12) Patent Application Publication
(10) Pub. No.: US 2026/0064560 A1
(43) Pub. Date: Mar. 5, 2026

(54) UPDATING COMPUTATIONAL WORKFLOW USING TRACE FEEDBACK

(71) Applicant: Microsoft Technology Licensing, LLC, Redmond, WA (US)

(72) Inventors: Ching-An CHENG, Redmond, WA (US); Aiming NIE, Stanford, CA (US); Adith SWAMINATHAN, Bellevue, WA (US); Ahmed AWADALLAH, Redmond, WA (US)

(73) Assignee: Microsoft Technology Licensing, LLC, Redmond, WA (US)

(21) Appl. No.: 18/817,033

(22) Filed: Aug. 27, 2024

(51) Int. Cl. G06F 11/34; G06F 8/41

(52) U.S. Cl. CPC G06F 11/3466; G06F 8/41

(57) ABSTRACT

A computing system including one or more processing devices configured to receive context data. The one or more processing devices obtain a workflow graph of a computational workflow. The one or more processing devices process a workflow input at the computational workflow to obtain a workflow output. The one or more processing devices select an adjustable parameter included in the computational workflow. The one or more processing devices compute a trace feedback including an execution trace of the processing of the workflow input starting at a selected workflow node that includes the selected adjustable parameter. The trace feedback further includes an output feedback received in response to the workflow output. The one or more processing devices compute a parameter update to the selected adjustable parameter based at least in part on the context data and the trace feedback and apply the parameter update to the selected adjustable parameter.

### BACKGROUND

Many applications of machine learning (ML) models integrate those ML models into model scaffolding systems, which include logic that programmatically calls an ML model and integrates the outputs of the ML model into an overarching computational workflow. Computational workflows that integrate large language models (LLMs), large multimodal models (LMMs), other ML models, orchestration, retrievers, tools, etc., power many state-of-the-art AI applications: from chatbots, coding assistants, and robots to multi-agent systems. However, designing a computational workflow typically requires laborious engineering, because many heterogeneous parameters (e.g., prompts, orchestration code, and ML hyper-parameters) are involved. Moreover, after deployment, erroneous behaviors of the workflow persist unless a developer manually updates it.

### SUMMARY

According to one aspect of the present disclosure, a computing system is provided, including one or more processing devices configured to receive context data. The one or more processing devices are further configured to obtain a workflow graph of a computational workflow. The computational workflow includes a plurality of workflow nodes that each include a respective adjustable parameter. The workflow graph is structured as a directed acyclic graph (DAG). The one or more processing devices are further configured to process a workflow input at the computational workflow to obtain a workflow output. The one or more processing devices are further configured to select an adjustable parameter included in the computational workflow. The one or more processing devices are further configured to compute a trace feedback including an execution trace of the processing of the workflow input starting at a selected workflow node that includes the selected adjustable parameter. The execution trace specifies a subgraph of the DAG. The trace feedback further includes an output feedback received in response to the workflow output. The one or more processing devices are further configured to compute a parameter update to the selected adjustable parameter based at least in part on the context data and the trace feedback. The one or more processing devices are further configured to apply the parameter update to the selected adjustable parameter.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A-1C schematically show a computing system at which an adjustment to a computational workflow is performed, according to one example embodiment.

FIG. 2 schematically shows an example of a plurality of parameter update iterations performed at the computing system when solving an Optimization with Trace Oracle (OPTO) problem, according to the example of FIGS. 1A-1C.

FIG. 3A shows an example of a recursive graph traversal algorithm that may be used to propagate a parameter update through an execution trace, according to the example of FIGS. 1A-1C.

FIG. 3B shows an example of a minimal subgraph propagator (MSP) algorithm that may be executed when executing the recursive graph traversal algorithm of FIG. 3A.

FIG. 4 shows a plot of the results of a differentiable optimization problem experiment, according to the example of FIGS. 1A-1C.

FIGS. 5A-5B show plots of the results of a traffic control experiment, according to the example of FIGS. 1A-1C.

FIG. 6 shows a plot of the results of a Battleship experiment, according to the example of FIGS. 1A-1C.

FIGS. 7A-7C show plots of the results of a simulated robot manipulator control experiment, according to the example of FIGS. 1A-1C.

FIG. 8A shows a flowchart of a method for use with a computing system to tune a computational workflow, according to the example of FIGS. 1A-1C.

FIG. 8B shows example steps of the method of FIG. 8A that may be performed in some examples to select the adjustable parameter when the plurality of workflow nodes include at least one machine learning model.

FIG. 8C shows additional steps of the method of FIG. 8A that may be performed in some examples over a plurality of parameter update iterations.

FIG. 9 shows a schematic view of an example computing environment in which the computing system of FIGS. 1A-1C may be instantiated.

### DETAILED DESCRIPTION

The following discussion pertains to a class of optimization problems motivated by automating the design and update of computational workflows. Computational workflows produce optimization problems with heterogeneous parameters, rich feedback (e.g. console output and user's verbal responses), and intricate objectives (beyond maximizing a score). Moreover, a workflow can have interdependent steps (e.g., adaptive orchestration, feedback control loops) and/or involve semi-black-box operations whose behavior cannot be succinctly captured (e.g., ML models, simulations). As a result, the structure of the computation may change as the parameters and the inputs of the workflow vary.

Due to its complexity, computational workflow tuning is usually framed as a black-box or algorithm configuration problem that is addressed using general techniques such as Bayesian Optimization, Evolutionary Algorithms, and Reinforcement Learning (RL) that use scalar scores as feedback. Recently, LLM-based workflow tuning approaches have been developed. These approaches leverage the priors of LLMs learned from large pre-training corpora to modify complex prompts and codes. However, these existing approaches typically use scalar feedback in a workflow that includes only a single stage (e.g., one LLM call). Since one observation of scalar feedback alone does not provide an improvement signal, these existing LLM-based techniques are very inefficient when the parameter space is large (e.g., the space of code fragments or natural language prompts).

An end-to-end computational workflow tuning approach that generalizes backpropagation is provided herein. AutoDiff frameworks have scaled backpropagation to optimize differentiable workflows (i.e., neural networks) with billions of parameters. The systems and methods provided herein may be used to jointly tune the parameters in general computational workflows, including workflows that include non-differentiable stages. Thus, the systems and methods provided below allow ML model training techniques to be extended to scaffolded machine learning workflows that include one or more other components that are used in conjunction with an ML model.

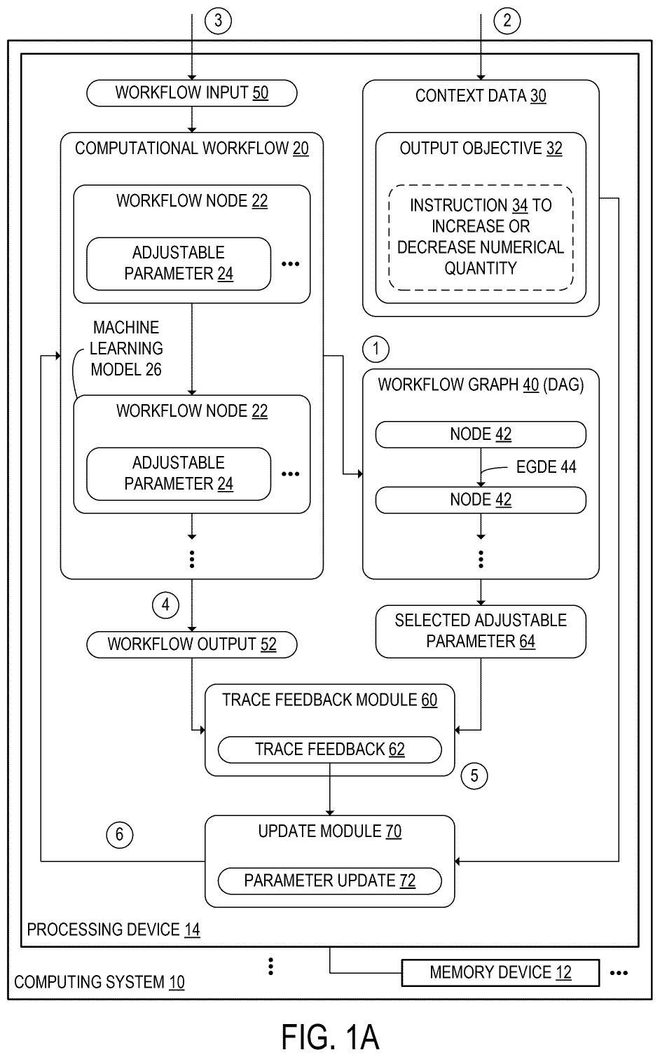

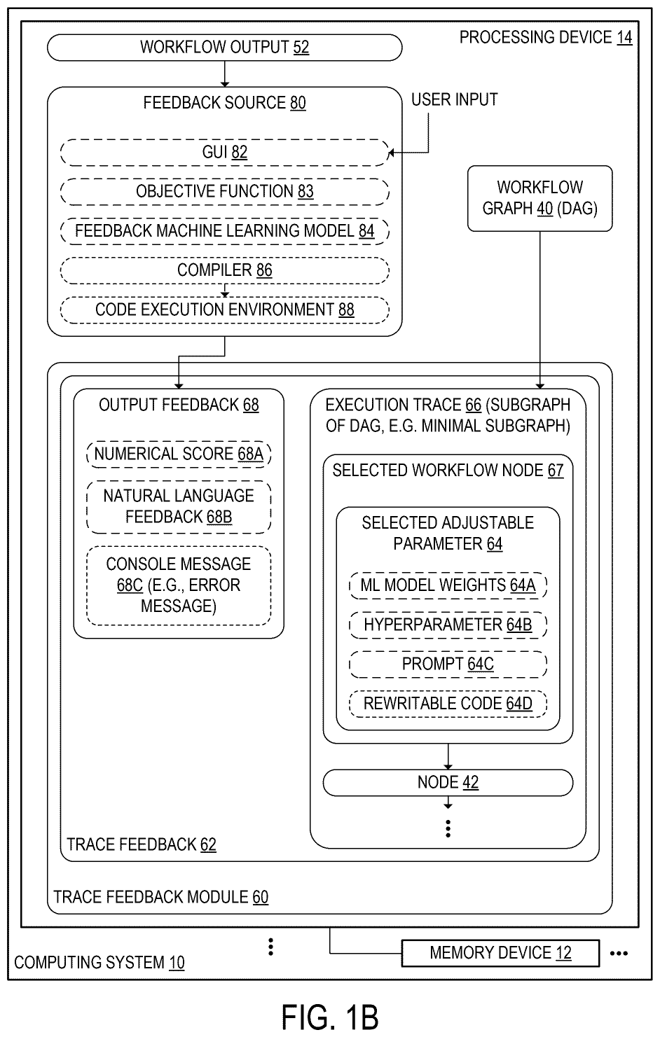

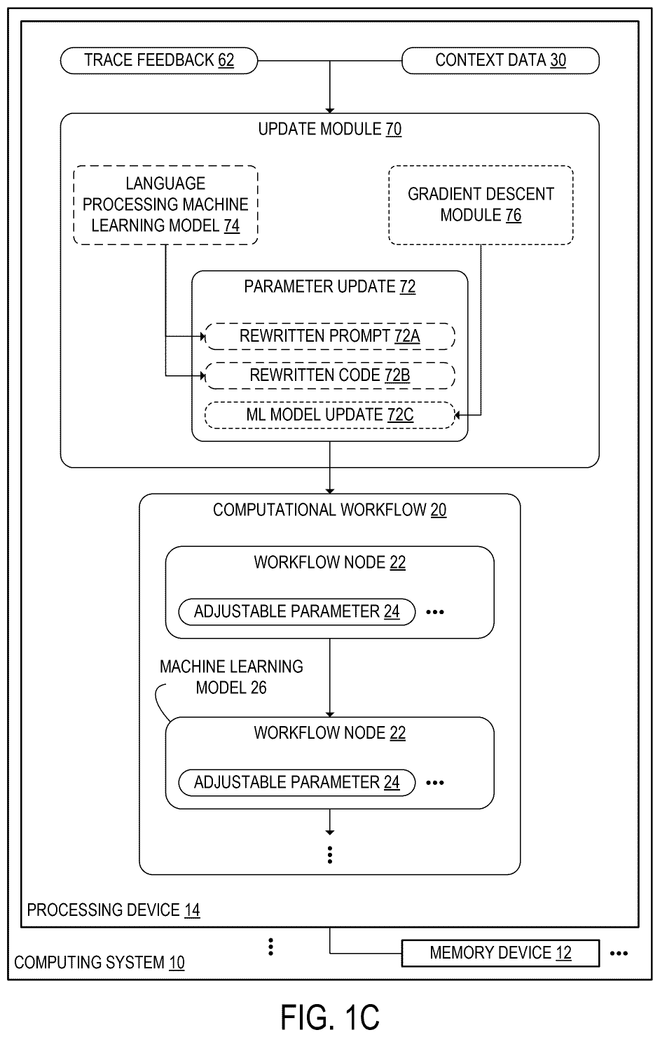

FIGS. 1A-1C schematically show a computing system 10 at which an adjustment to a computational workflow 20 is performed. The computing system 10 includes one or more memory devices 12 and one or more processing devices 14. The one or more memory devices 12 may, for example, include one or more volatile memory devices and one or more non-volatile storage devices. The one or more processing devices 14 may, for example, include one or more central processing units (CPUs), graphics processing units (GPUs), neural processing units (NPUs), and/or other types of hardware accelerators.

In some examples, the one or more memory devices 12 and/or the one or more processing devices 14 may include a plurality of physical components distributed among a plurality of different physical computing devices. For example, the one or more memory devices 12 and/or the one or more processing devices 14 may be included in a networked system of multiple physical computing devices located in a data center. Portions of the functionality of the one or more memory devices 12 and/or the one or more processing devices 14 may additionally or alternatively be performed at one or more client computing devices.

FIG. 1A schematically shows a plurality of steps performed at the one or more processing devices 14 during computational workflow tuning. At step 1, the one or more processing devices 14 are configured to obtain a workflow graph 40 of a computational workflow 20. The computational workflow 20 includes a plurality of workflow nodes 22 that each include a respective adjustable parameter 24. The workflow nodes 22 are computing processes included in the computational workflow 20. For example, as discussed in further detail below, the plurality of workflow nodes 22 may include at least one machine learning model 26. Other types of computing processes may also be included in the computational workflow 20.

The workflow graph 40 of the computational workflow 20 is structured as a directed acyclic graph (DAG). Instead of directly corresponding to the workflow nodes 22 of the computational workflow 20, the nodes 42 of the workflow graph 40 may instead each represent an input, a parameter, or a result of a computational step included as a workflow node 22 in the computational workflow 20. For example, as discussed in further detail below, a node 42 of the workflow graph 40 may indicate a prompt used as an input to an ML model 26 or code generated at the ML model 26. In some examples, the one or more processing devices 14 may be configured to programmatically construct the workflow graph 40. In other examples, the workflow graph 40 may be received as a user input.

Although, in the example of FIG. 1A, the workflow graph 40 is a DAG, the workflow graph 40 may be some type of graph other than a DAG in some examples. For example, the workflow graph 40 may have a cyclic structure in examples in which the computational workflow 20 includes one or more recurrent neural networks. Data structures other than graphs may also be used to represent the computational workflow 20 in some examples. For example, the one or more processing devices 14 may be configured to encode the computational workflow 20 as a matrix. As another example, the one or more processing devices 14 may be configured to represent the computational workflow 20 as a finite factored set instead of as a DAG.

At step 2, as another input to computational workflow tuning, the one or more processing devices 14 are further configured to receive context data 30. The context data 30 may specify an output objective of the computational workflow 20. In some examples, the context data 30 may be received in text form as a natural language input, such as “Follow the feedback.” Other information such as prior computational workflow tuning history may also be included in the context data 30, as discussed in further detail below.

At step 3, the one or more processing devices 14 are further configured receive a workflow input 50. At step 4, the one or more processing devices 14 are further configured to process the workflow input 50 at the computational workflow 20 to obtain a workflow output 52. In some examples, the output objective 32 specified in the context data 30 may be defined with reference to this workflow output 52. For example, the context data 30 may include an instruction 34 to increase or decrease a numerical quantity included in the workflow output 52.

The one or more processing devices 14 are further configured to select an adjustable parameter 64 included in the computational workflow 20. The selected adjustable parameter 64 is selected for modification from among the plurality of adjustable parameters 24. In some examples, the selected adjustable parameter 64 is selected via user input, whereas in other examples, the one or more processing devices 14 are configured to programmatically identify the selected adjustable parameter 64.

At step 5, the one or more processing devices 14 are further configured to execute a trace feedback module 60 at which a trace feedback 62 is computed. The trace feedback module 60 is shown in further detail in FIG. 1B. As depicted in the example of FIG. 1B, the trace feedback 62 includes an execution trace 66 of the processing of the workflow input 50. The execution trace 66 starts at a selected workflow node 67 that includes the selected adjustable parameter 64 and ends at the workflow output 52.

The one or more processing devices 14 are configured to compute the execution trace 66 using the workflow graph 40. The execution trace 66 specifies a subgraph of the DAG structure of the workflow graph 40. In some examples, the one or more processing devices 14 may be configured to compute the subgraph of the workflow graph 40 as a minimal subgraph between the selected adjustable parameter 64 and the workflow output 52. The minimal subgraph g_{X→Y} connecting nodes [symbol] and a node Y is defined as g_{X→Y}:= [symbol] U{Y}∪ {Z|Z∈ ancestors (Y), Z∈ descendents (X), X∈ [symbol] }.

FIG. 1B further shows examples of selectable adjustable parameters 64 that may be included in the selected workflow node 67 in examples in which the selected workflow node 67 is a machine learning model 26. In some examples, the one or more processing devices 14 may be configured to select a plurality of machine learning model weights 64A included in the machine learning model 26 as the selected adjustable parameter 64. Adjusting the computational workflow 20 may accordingly include performing further training at the machine learning model 26. As another example, the one or more processing devices 14 may be configured to select a hyperparameter 64B of the machine learning model 26, such as a temperature or a learning rate, as the selected adjustable parameter 64.

In some examples, the one or more processing devices 14 may be configured to select a prompt 64C received at the machine learning model 26 as the selected adjustable parameter 64. The prompt 64C may be a text prompt or may additionally or alternatively include other types of prompt data such as image data. The prompt 64C may be received at the machine learning model 26 as initial contents of a context window for which the machine learning model 26 is configured to autoregressively generate a completion.

In addition to the execution trace 66, the trace feedback 62 further includes an output feedback 68 received in response to the workflow output 52 from a feedback source 80. The feedback source 80, as discussed in further detail below, is an additional input source that is external to the computational workflow 20.

In some examples, the output feedback 68 may include a numerical score 68A. In examples in which the context data 30 includes an output objective 32 specified as an instruction 34 to increase or decrease a numerical quantity, the numerical quantity may be the numerical score 68A included in the output feedback 68. The numerical score 68A may, in some examples, be received as a user input via a graphical user interface (GUI) 82 that is used as the feedback source 80. At the GUI 82, the one or more processing devices 14 may be configured to present the workflow output 52 to a user for scoring (e.g., on factual accuracy or compliance with a content policy). In other examples, the numerical score 68A may be computed by programmatically evaluating an objective function 83 that receives the workflow output 52 as an input. A feedback machine learning model 84 may alternatively be used to compute the numerical score 68A in some examples.

In some examples, the output feedback 68 may include natural language feedback 68B. The natural language feedback 68B may be received from the user via the GUI 82. Alternatively, the natural language feedback 68B may be generated at the feedback machine learning model 84.

In some examples, the selected adjustable parameter 64 may be rewritable code 64D. In such examples, the one or more processing devices 14 may be configured to compute the output feedback 68 at least in part at a compiler 86 and a code execution environment 88. The output feedback 68 computed at least in part at the compiler 86 and the code execution environment 88 may include a console message 68C generated at the compiler 86 or the code execution environment 88. For example, the output feedback 68 may include an error message generated at the compiler 86 or the code execution environment 88 during compilation or execution of the rewritable code 64D. The output feedback 68 may accordingly indicate whether the rewritable code 64D compiles and runs without errors.

In some examples, the trace feedback 62 may be a text feedback in which the execution trace 66 and the output feedback 68 are both provided in text form. In examples in which the trace feedback 62 is generated as a text feedback, the one or more processing devices 14 may be further configured to jointly process the execution trace 66 and the output feedback 68 at one or more text processing tools as discussed below.

Returning to FIG. 1A, subsequently to computing the trace feedback 62, the one or more processing devices 14 are further configured to execute an update module 70. At the update module 70, the one or more processing devices 14 are further configured to compute a parameter update 72 to the selected adjustable parameter 64 based at least in part on the context data 30 and the trace feedback 62. At Step 6, the one or more processing devices 14 are further configured to apply the parameter update 72 to the selected adjustable parameter 64. The one or more processing devices 14 are accordingly configured to tune the workflow node 22 of the computational workflow 20 in which the selected adjustable parameter 64 is included.

The update module 70 is shown in further detail in FIG. 1C. In some examples, as shown in FIG. 1C, the update module 70 may include a language processing machine learning model 74. The language processing machine learning model 74 may be an LLM or an LMM. In examples in which the trace feedback 62 is a text feedback, the one or more processing devices 14 may be configured to compute the parameter update 72 at least in part at the language processing machine learning model 74. For example, the trace feedback 62 and the context data 30 may be loaded into a template, and the filled template may be used as a prompt for the language processing machine learning model 74. The output of the language processing machine learning model 74 may, for example, include an updated version of a prompt 64C or rewritable code 64D that is indicated in the trace feedback 62 as the selected adjustable parameter 64. The one or more processing devices 14 may accordingly be configured to compute the parameter update 72 as a rewritten prompt 72A or rewritten code 72B.

The update module 70 may additionally or alternatively include a gradient descent module 76 in some examples. At the gradient descent module 76, the one or more processing devices 14 may be configured to perform gradient descent over the machine learning model 26 included in the computational workflow 20 to compute the parameter update 72 as a machine learning model update 72C. In other examples, the one or more processing devices 14 may be configured to perform types of ML model updates 72C other than gradient descent, such as modification of a hyperparameter 64B.

The computing system 10 shown in FIGS. 1A-1C is configured to solve a type of iterative optimization problem referred to as an Optimization with Trace Oracle (OPTO) problem. Formalism related to OPTO problems is provided below. In an OPTO problem, a computational graph g is a represented as a DAG, where a node represents an object (such as tensors, strings, etc.) and an edge denotes an input-output relationship. A node without parents is referred to as a root and a node without children is referred to as a leaf. The roots and leaves are the inputs and outputs of the computational graph.

In an OPTO problem, some inputs are marked as trainable parameters, which are denoted as {X_{θ}}. For a node X, its parents are the inputs to an operator that creates X. The descendants of node X are those that can be reached from X following the directed edges; the ancestors are defined conversely. Without loss of generality, the computational operators are assumed in the following discussion to have unitary outputs. A multi-output operator may be modeled by a single-output operator and single-output indexers. Accordingly, the operator that creates the child node may be associated with the child node, and the full computation can be represented compactly as a DAG without explicitly representing the operators.

An OPTO problem instance is defined by a tuple (Θ, ω, [symbol] ), where Θ is the parameter space, ω is the context of the problem, and [symbol] is a trace oracle. In each iteration, the solver selects a parameter θ∈Θ. The selected parameters can be heterogeneous across iterations. Then the trace oracle [symbol] returns a trace feedback, denoted as τ=(f, g), where g is the execution trace represented as a DAG (where X_{θ} are contained in the root nodes of g), and f is the feedback provided to exactly one of the output nodes of g. Finally, the solver uses the trace feedback τ to update the parameter according to the context ω and proceeds to the next iteration.

The output feedback f may, for example, be received as scores, gradients, hints/explanation expressed in natural language, and/or console messages, as discussed above. The context ω provides invariant information to interpret the output feedback f as well as any known side-information, e.g., desired properties of the parameters. The context ω is fixed for an OPTO problem instance (similar to an instruction, or a problem definition), whereas the output feedback f can change with the parameter θ∈Θ and the resulting computation g. For example, ω may be “Minimize a loss function,” and f may be a loss. Alternatively, ω can be open-ended, such as “Follow the feedback,” and f can describe how an output should be changed.

OPTO differs from a black-box setup in that the execution trace g shows the computational path toward the output, which provides information to construct a parameter update direction from f and ω. In the loss function minimization example above, when the execution trace g is missing, it is unclear how the parameter can be improved given only a point evaluation of f. On the other hand, with g, an update direction (e.g., a gradient) can be efficiently derived. The structure of the computational graph g returned by the Trace Oracle [symbol] can be different each iteration, since the workflow can change with different inputs and parameters.

To ground the OPTO setup, the following examples are provided that describe how an OPTO framework may be adapted to existing problems.

Example 1 (Neural network with backpropagation). The parameters are the weights. g is the neural computational graph and f is the loss. An example context ω can be “Minimize loss”. The backpropagation algorithm is embedded in the OPTO solver. For example, an OPTO solver can use t to compute the propagated gradient at each parameter and can apply a gradient descent update.

Example 2 (RL). The parameters are included in the policy. g is the trajectory (of states, actions, rewards) resulting from running the policy in a Markov decision process; that is, g documents the graphical model of how an action generated by the policy, applied to the transition dynamics which then returns the observation and reward, etc. f can be the termination signal or a success flag. ω can be “Maximize return” or “Maximize success”.

Example 3 (Prompt tuning for an LLM agent). The parameters are the prompt of an LLM workflow. g is the computational graph of the agent and f is the feedback about the agent's behavior (which can be scores or natural language). ω can be “Maximize score” or “Follow the feedback”.

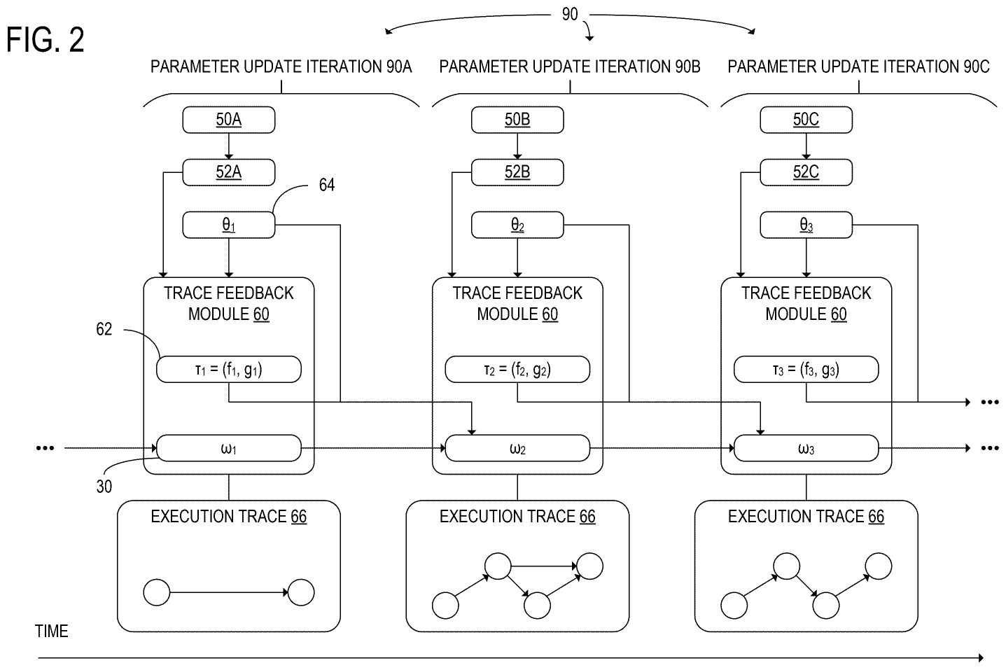

FIG. 2 schematically shows an example of a plurality of parameter update iterations 90 performed at the computing system 10 when solving an OPTO problem. In the plurality of parameter update iterations 90, the one or more processing devices 14 are configured to process respective workflow inputs 50 at the computational workflow 20. In the example of FIG. 2, the one or more processing devices 14 are configured to process a first workflow input 50A at a first parameter update iteration 90A, a second workflow input 50B at a second parameter update iteration 90B, and a third workflow input 50C at a third parameter update iteration 90C to respectively obtain a first workflow output 52A, a second workflow output 52B, and a third workflow output 52C.

In the plurality of parameter update iterations 90, the one or more processing devices 14 are further configured to modify respective adjustable parameters 24 of two or more of the workflow nodes 22. According to the example of FIG. 2, the one or more processing devices 14 are configured to modify a first adjustable parameter θ₁ at the first parameter update iteration 90A, a second adjustable parameter θ₂ at the second parameter update iteration 90B, and a third adjustable parameter θ₃ at the third parameter update iteration 90C.

The one or more processing devices 14 are further configured to compute sets of trace feedback 62 with different respective execution traces 66 at the different parameter update iterations 90. In the first parameter update iteration 90A, the one or more processing devices 14 are configured to compute a trace feedback τ₁=(f₁, g₁); in the second parameter update iteration 90B, the one or more processing devices 14 are configured to compute a trace feedback τ₂=(f₂, g₂); and in the third parameter update iteration 90C, the one or more processing devices 14 are configured to compute a trace feedback τ₃=(f₃, g₃). The execution traces 66 included in these sets of trace feedback each have a different DAG structure. The one or more processing devices 14 are accordingly configured to modify different portions of the computational workflow 20 at different parameter update iterations 90, which may allow end-to-end tuning of the computational workflow 20.

In the example of FIG. 2, at each of the parameter update iterations 90, the one or more processing devices 14 are further configured to add an indication of the selected adjustable parameter 64 and the output feedback 68 to the context data 30. The one or more processing devices 14 are configured to use context data ω₁ at the first parameter update iteration 90A, context data ω₂ at the second parameter update iteration 90B, and context data ω₃ at the third parameter update iteration 90C. The one or more processing devices 14 are accordingly configured to update the context data 30 with records of the modifications that have been made to the computational workflow 20 earlier in the tuning process. For example, the updates to the context data 30 may be used to avoid redundant visits to previous values of a selected adjustable parameter 64.

The following discussion presents an example of an OPTO problem implementation framework referred to as Trace. Trace provides a light-weight Python tool to implement the trace oracle of OPTO when tuning computational workflows. The trace oracle is implemented using “node” and “bundle” wrappers. Through the OPTO framing, Trace separates the design of solvers and domain-specific components so that the solvers can be built to work across multiple workflows and domains.

Trace is based on two primitives:

“node” is the wrapper of Python objects. When wrapped, a Python object is registered as a unique node in the global graph of Trace. A node can be set “trainable,” which makes the node a parameter in OPTO. In addition, when using “node” to declare a parameter, the user can also describe constraints (in natural language) for the parameter to obey.

“bundle” is the decorator to turn Python methods into operators. When a function is decorated, its docstring and source code are recorded as the definition of the operator. The user may thereby specify the level of granularity at which the workflow graph is defined. Moreover, functions decorated by “bundle” can be set “trainable” as well, which means that the code of the decorated method becomes a parameter.

Using Trace to tune a computational workflow includes the following steps. First, the user declares the parameters of the computational workflow using “node” and “bundle,” and also defines the conceptual blocks of the computational workflow as operators in the computational graph using “bundle.” Then the user defines an OPTO solver and provides the context data ω. Alternatively to the user defining the context data ω, the OPTO solver may use the default context “Follow the feedback.”

After the OTPO problem has been defined, Trace programmatically repeats the following steps:
1) Execute the decorated workflow. As the computational workflow runs, a DAG is built in the backend, logging the computed results and their connections.
2) Initiate the propagation of the output feedback to the parameters by calling “backward.” (Any execution error is also treated as feedback). Internally, Trace extracts the minimal subgraph g connecting the parameters and the output and sends the OPTO solver the trace feedback τ=(f, g).
3) Call the “step” method of the OPTO solver to update the selected adjustable parameters.

There are multiple ways to represent a computational workflow as a computational graph. In one extreme, the entire computation process is expressed as a single operator. At the another extreme, every low-level computation is also an operator in the graph. In Trace, the granularity of the computational workflow is determined by how “bundle” is applied, as a set of operations underneath “bundle” is treated as one operator summarized by the docstring of that decorated code block. Different choices of workflow representation granularity trade off the complexity of the overall graph and the amount of description provided for each operator. Grouping the entire workflow into a single operator makes the graph simple but requires more descriptions to faithfully capture the workflow. On the other hand, not all details matter in workflow tuning, so exposing every low-level operator in the workflow graph can make the workflow graph unnecessarily cluttered.

Apart from architecture design, the user may also select what information is included in the context data ω versus the description of each operator. For a single problem, the user may provide details of all operators in the workflow graph g through the context data ω. However, providing the details in this manner includes manually crafting a context for every workflow. Instead, the user may provide a description of the operators when they are defined using “bundle.” Trace then programmatically generates the workflow-specific information, and the same context data ω may be shared across multiple computational workflows.

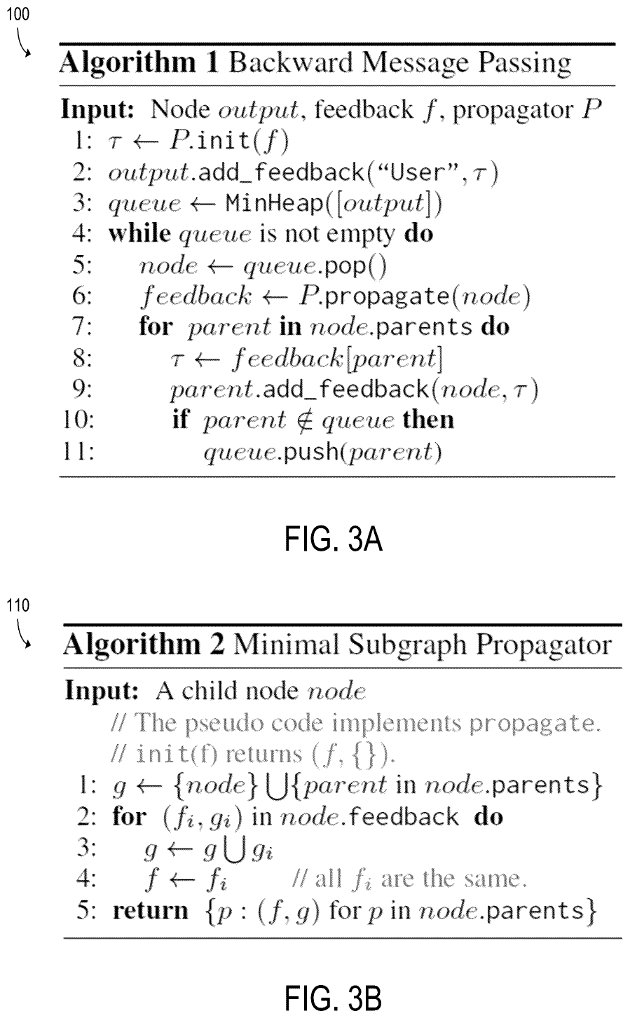

FIG. 3A shows an example of a recursive graph traversal algorithm 100 that may be used in Trace to propagate the parameter update 72 through the reversed topological ordering of the execution trace 66. By using different propagators, the recursive graph traversal algorithm 100 can implement different forward-backward updating approaches such as backpropagation. In backpropagation, the message is the gradient ∇ᵢ and the “propagate” functions returns

$${J}_{i}^{T} {\sum }_{j} {∇}_{j}$$

to its ith parent, where Jᵢ is the Jacobian to the ith parent and the gradient ∇ⱼ received from the jth child.

FIG. 3B shows an example of a minimal subgraph propagator (MSP) algorithm 110 that may be used as the propagator P in the recursive graph traversal algorithm 100. The MSP algorithm 110 propagates the trace feedback τ=(f, g), where the computational graph g is implemented as a priority queue. The trace oracle in an OPTO problem may be implemented using the recursive graph traversal algorithm 100 and the MSP algorithm 110.

For a graph with N nodes and maximum degree W, the recursive graph traversal algorithm 100 and the MSP algorithm 110 have time complexity O(WN² log N) and space complexity O(WN). By contrast, backpropagation has time and space complexities of O(Nd²) and O(d), where d is the maximal dimension of the tensors. This difference occurs because in the most general setting of computational graphs and feedback, the propagated feedback (no matter how it is represented) does not have a constant size and uses a full description of the subgraph.

For a generic computational graph of N nodes, the MSP algorithm 110 has a worst-case description length complexity of Ω(N). However, the MSP algorithm 110 is typically much less computationally expensive than the forward pass through the computational workflow 20 in which the workflow output 52 is generated.

An example LLM-based solver for OPTO problems, referred to as OptoPrime, is discussed below. One core challenge of designing an LLM-based OPTO solver is how to represent the execution trace subgraph g (which can involve various graph structures and heterogenous data) to an LLM in a manner that allows the LLM to accurately estimate downstream effects of a parameter update. In OptoPrime, the coding and debugging capabilities of the LLM are used to perform the parameter update. The trace feedback computed by Trace is presented as a pseudo-algorithm problem: the subgraph g is presented as a report of code with information about the computed values and descriptions of functions used in g. Based at least in part on this report, the LLM is prompted to update the parameters in g.

The following pseudocode is an example of a report generated by Trace. In this example, the program is x=Node(−1.0); z=bar(x)*(bar(x)+1) and the output objective is

$${max}_{x} z .$$

#Code:
a = bar(x)
y = add(b, a)
z = mul(a, y)
#Definitions:
[mul] This is a multiply operator.
[add] This is an add operator.
[bar] This is a method that does negative scaling.
#Inputs:
b=1.0
#Others:
a=2.0
y=3.0
#Output
z=6.0
#Variable
x =−1.0
#Feedback:
Output should be larger.

The above report is generated by merging the minimal subgraphs from child nodes of the parameter nodes. The above pseudocode specifies a computational graph as defined by the “bundle” decorator of Trace.

The LLM is prompted with a Reason-Act Chain-of-Thought (ReAct-CoT) prompt that requests reasoning about the subgraph g, an answer to a problem statement posed in the feedback, and a suggested change to an adjustable parameter. A suggested parameter change may be extracted from the response generated at the LLM and used to update the selected adjustable parameter.

In some examples, as discussed below, single-output feedback generated for only a current forward pass may be insufficiently informative to result in accurate tuning of the computational workflow. For example, the output feedback may take the form of reward values without describing how those reward values are computed. In such examples, the past parameter-feedback pairs may be tracked and used as in-context examples. The context data may be augmented with prior trace feedback, as shown in the example of FIG. 2. Accordingly, OptoPrime may be provided with memory that tracks the feedback received in earlier parameter update iterations.

The following experiments were performed to evaluate the Trace framework with OptoPrime. In these experiments, the existing LLM optimizer OPRO was implemented as a baseline. OPRO does not use the execution trace but instead relies on memory of parameter-feedback pairs. GPT-4-0125-Preview was used as the LLM in these experiments. The experiments were run on a standard PC with 16 GB RAM, and Trace introduced no measurable overhead on executing the workflow. In the following descriptions of the experiments. Trace+OptoPrime is denoted as Trace.

The first experiment tested whether OptoPrime can solve classical differentiable optimization problems, since they are a special case of OPTO. Consider the problem of

$${min}_{x} \vert h ( x ) - {y}^{*} \vert$$

IVI a target y*. A synthetic task environment was constructed that randomly created y* and the computational graph of h with arbitrarily complex connections between numerical variables. Trace was evaluated in this experiment, as was a variant (Trace Masked) in which OptoPrime did not receive the execution subgraph. The output feedback was “The output should be <larger/smaller>”. The performance of Trace and Trace Masked was compared to PyTorch's implementation of the Adam optimizer.

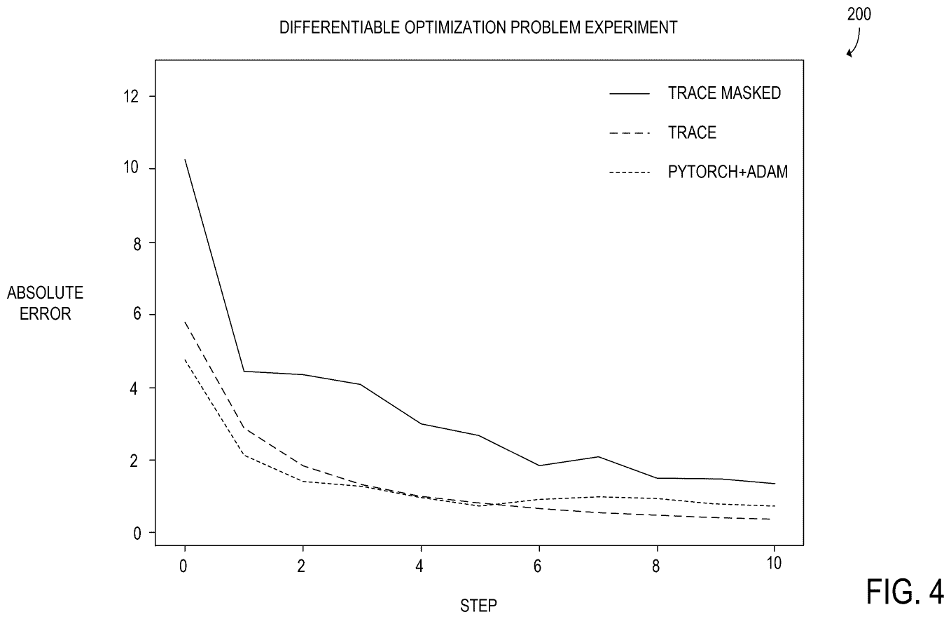

In the differentiable optimization problem experiment, 30 trials were run over different randomly generated problems. The same random inputs were used for each of the methods. FIG. 4 shows a plot 200 of the results of the differentiable optimization problem experiment. On average, Trace was able to match the Adam optimizer; on the other hand, without access to the execution subgraph, the performance of Trace at finding y* was significantly reduced.

In another experiment, Trace was tested in a traffic control problem, which was an instance of hyperparameter tuning. UXSim was used to simulate traffic at a four-way intersection. The trainable parameters were two integers in [15, 90], which were the green light duration for each direction of traffic flow. The feedback was the estimated delay experienced by all vehicles due to intersections, and the goal of the solver was to minimize the delay using the fewest number of traffic simulations. To this end, the solver had a tradeoff between temporally distributed and variable demands. The baselines included a heuristic from the traffic control literature, SCATS, as well as two black-box optimization techniques: Gaussian Process Minimization (GP) and Particle Swarm Optimization (PSO). The methods each used the same starting parameters.

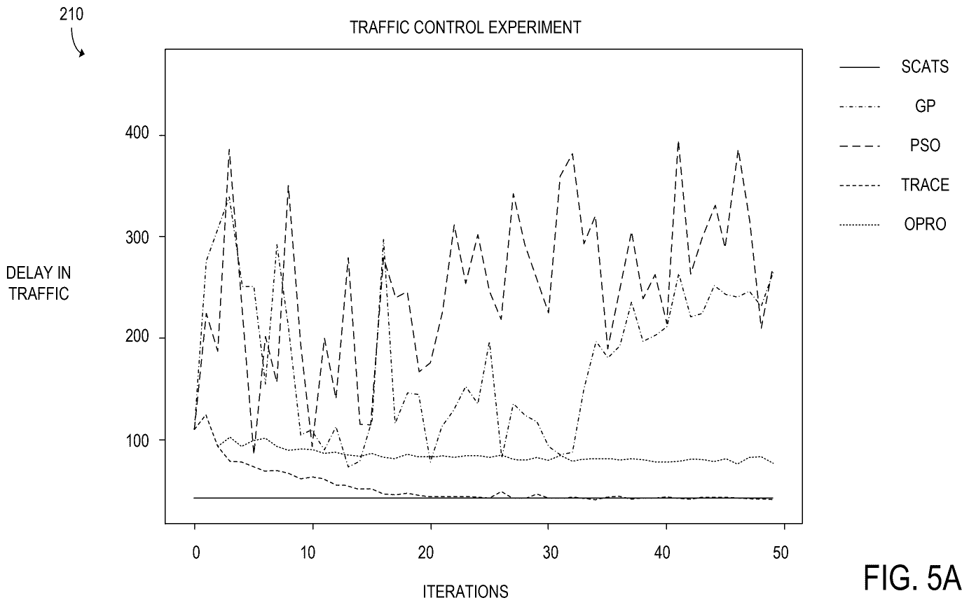

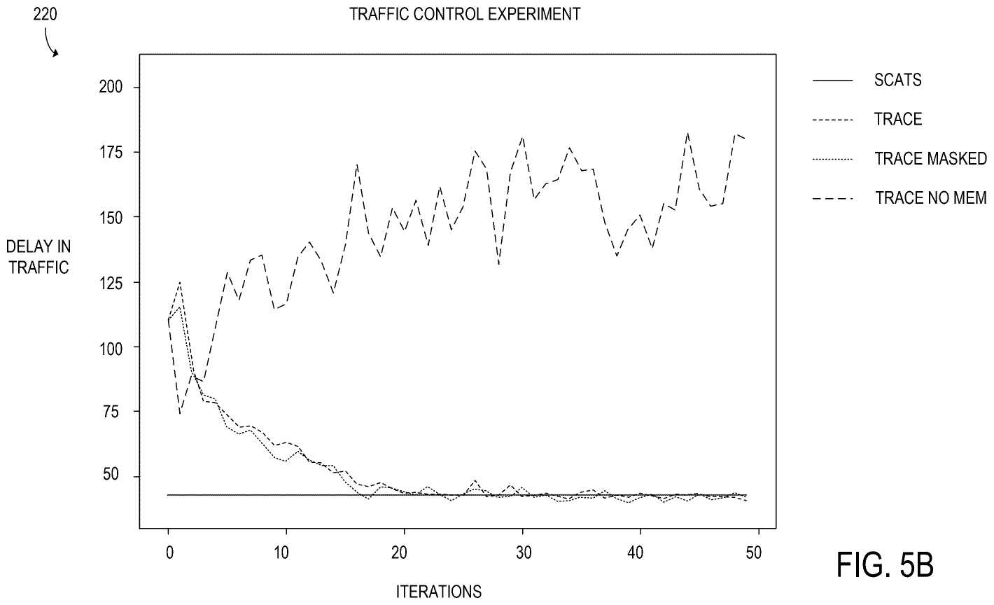

FIG. 5A shows a plot 210 of the results of the traffic control experiment. In the traffic control experiment, 50 iterations were insufficient for the convergence of GP and PSO. Given enough iterations, both eventually performed well. Trace was quickly competitive with the SCATS heuristic, whereas OPRO was not. A plot 220 of further results of the traffic control experiment are also shown in FIG. 5B. As shown in the plot 220, Trace performed significantly worse without memory. However, Trace with memory incurs additional overhead compared to other methods, since Trace constructs the workflow graph and queries an LLM with a longer prompt than that of OPRO.

An end-to-end workflow tuning experiment was also performed using Trace. Many LLM agents today, e.g., those specified by LangChain, DSPy, and Semantic Kernel, have many components. These libraries provide optimization tools to tune a small portion of their workflows, predominantly the prompt that goes into an LLM call. However, for building self-adapting agents that can modify their own behavior, only allowing changes to one part of a workflow but not others may limit the agents' flexibility. The end-to-end workflow tuning experiment was performed to test the capabilities of Trace in a joint prompt optimization and code generation task. This experiment included tuning three components of a given DSPy-based LLM agent: the meta-prompt “prompt_template”, a function “create_prompt” that modifies the prompt with the current question, and a function “extract_answer” that post-processes the output of an LLM call.

Unlike a typical LLM benchmark evaluation, the end-to-end workflow tuning experiment used an automatic evaluation function to compare the output of the LLM to ground truth. The LLM was evaluated on whether it generated outputs not only with the correct answer but also in the correct format. Big-Bench Hard was used as the problem source (15 examples for training, 5 for validation, and the rest for testing). Trace was compared with DSPy's COPRO module (which optimizes the meta-prompt).

The following table summarizes the results of the end-to-end workflow tuning experiment. In this table, PO refers to DSPy's prompt optimizer COPRO, and CoT refers to chain-of-thought.

| | BBH all | NLP | Algorithmic |
|---|---|---|---|
| | (23 tasks) | (12 tasks) | (11 tasks) |
| DSPy | 41.6 | 53.8 | 32.6 |
| DSPy-PO | 55.3 | 69.0 | 45.2 |
| DSPy + CoT | 70.4 | 73.7 | 68.0 |
| DSPy-PO + CoT | 71.6 | 73.9 | 70.0 |
| Trace | 59.5 | 70.9 | 51.1 |
| Trace + CoT | 78.6 | 75.8 | 80.6 |

As shown in the above table, Trace achieves higher performance than the COPRO optimizer, especially on algorithmic tasks, and exhibits a further increase in performance when chain-of-thought prompting is used.

An example of code learned during the end-to-end workflow tuning experiment is shown below:

```
## Iteration 0 ( initialization )
def create_prompt(self, prompt_template, question ):
  ″″″
  The function takes in a question and then add to the prompt for LLM to answer.
  Args:
  prompt_template: some guidance/hints/suggestions for LLM
  question: the question for the LLM to answer
  ″″″
  return prompt_template format(question)
## Iteration > 0
def create_prompt(self, prompt_template, question):
  ″″″
  The function takes in a question and then add to the prompt for LLM to answer.
  The prompt should now further instruct the LLM to carefully track the ball
  swaps occurring step-by-step.
  Args:
    prompt_template: some guidance/hints/suggestions for LLM
    question: the question for the LLM to answer
  ″″″
  prompt_template = ‘Process this carefully: Step-by-step.’ + prompt_template
  return prompt_template.format (question)
```

In another experiment, Trace was used to construct an agent that played a Battleship game. The policy of the agent had two components, “reason” and “act,” which were chained together and used to react to different board configurations. The “reason” and “act” nodes of the computational workflow were set as trainable. The Battleship environment provided feedback (binary reward) if the agent's action hit the hidden ships, and the goal was to hit all hidden ships as quickly as possible. Trace was used to perform iterative code generation. In addition, the performance of Trace was compared to OPRO and to a baseline that enumerated squares of the game board in a fixed order.

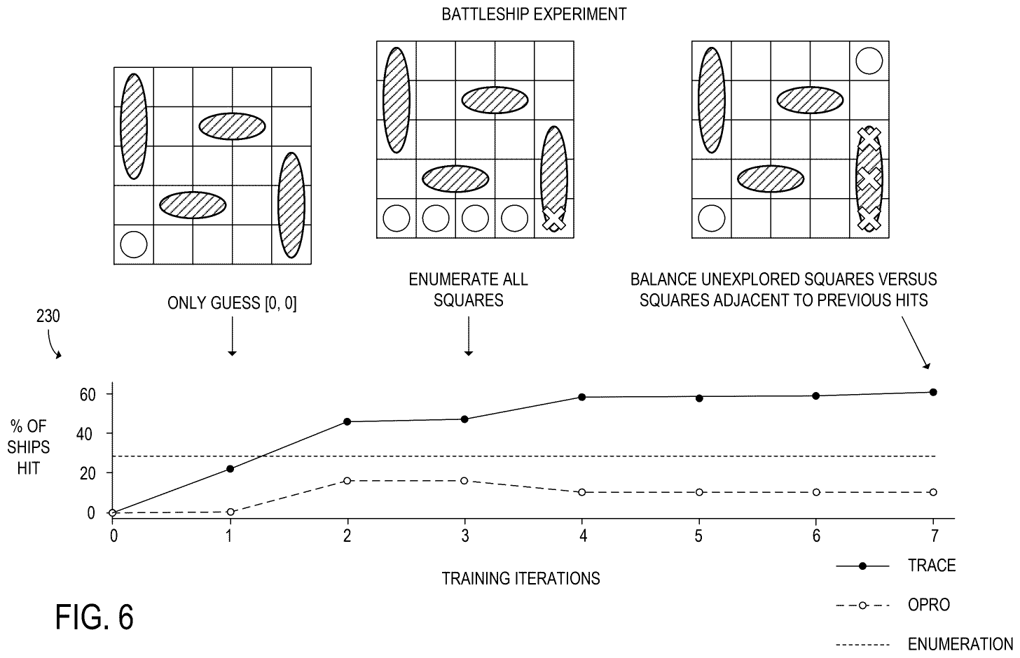

FIG. 6 shows a plot 230 of results of the Battleship experiment when the policies learned by Trace and OPRO were tested on new randomly generated games. With binary feedback, and in fewer than 7 attempts, Trace developed strategies that were increasingly complex and led to increasing success rates. At the first training iteration, the generated agent only guessed the square [0, 0]. At the third training iteration, the generated agent enumerated the squares in a fixed order. At the seventh training iteration, the generated agent balanced exploring squares in unexplored regions versus selecting squares adjacent to previous hits. Trace was able to develop these strategies based on the output feedback, without an explicit description of the mechanics of the Battleship game. In contrast, OPRO failed to exceed the performance of the enumeration baseline.

Another experiment tested the ability of Trace to tune long-horizon workflows with complex dependencies and to “backpropagate through time.” In this experiment, Trace was used to train controller code (in Python) for a simulated Sawyer robot manipulator. The Meta-World environment from LLF-Bench was used as the simulator. Three tasks were used: Reach, Pick-place, and Push. For each task, LLF-Bench provided a task instruction and the meaning of the action space, which were used as the context data ω of the OPTO problem. The execution trace included an observation expressed as a dictionary of vectors, where the vectors indicated the end-effector position, the puck position, the goal position, and the gripper status. The action space was a 4-dimensional vector that specified the relative position of the end-effector and the gripper state. In each timestep, the LLF-Bench Meta-World simulator returned the observation along with natural language feedback to guide the robot. An episode ended if the robot successfully solved the problem or ran out of time.

An episodic training setting was used. The initial conditions for all iterations in training were the same. The learned policy was evaluated in terms of success, starting from 10 held-out initial conditions. The task horizon was 10 steps, which was sufficient for task completion, and each training iteration had one rollout. The output feedback in the OPTO problem included success and return. In addition to controller code, the reset and step functions of the gym environment were decorated so that the entire rollout could be traced end-to-end. Trace was compared with OPRO; to run ORPO in the streaming OPTO setting, the OPRO implementation only proposed one candidate in each iteration, which was then evaluated and provided with the output feedback.

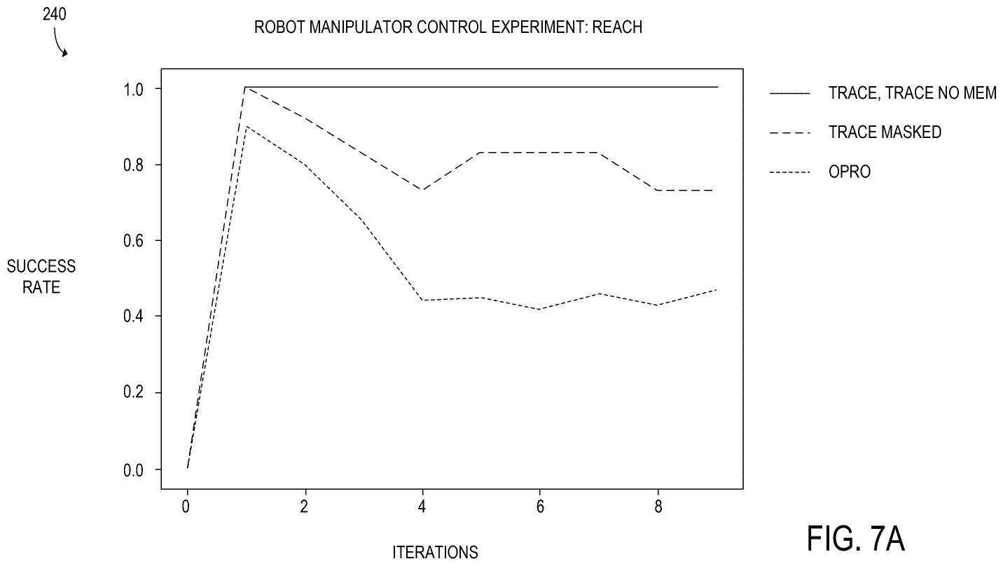

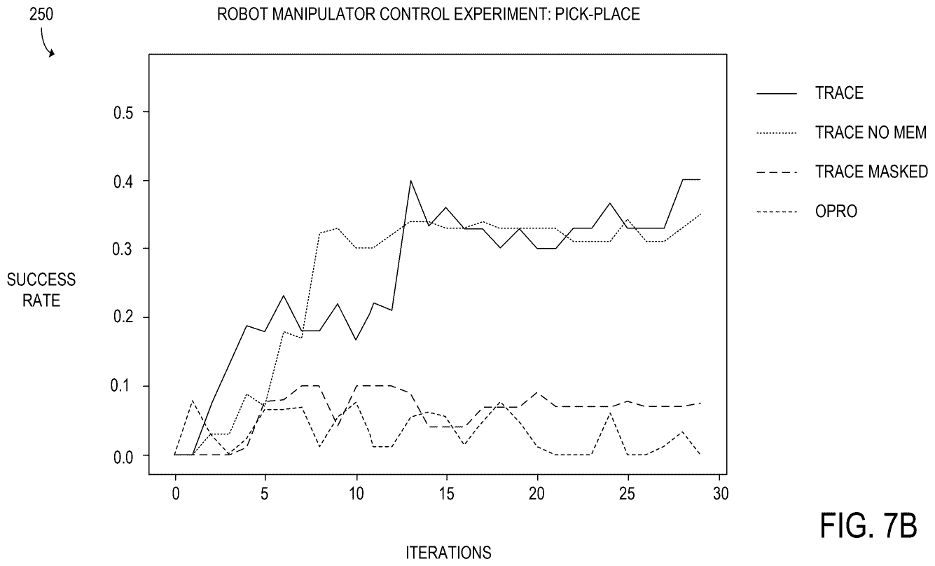

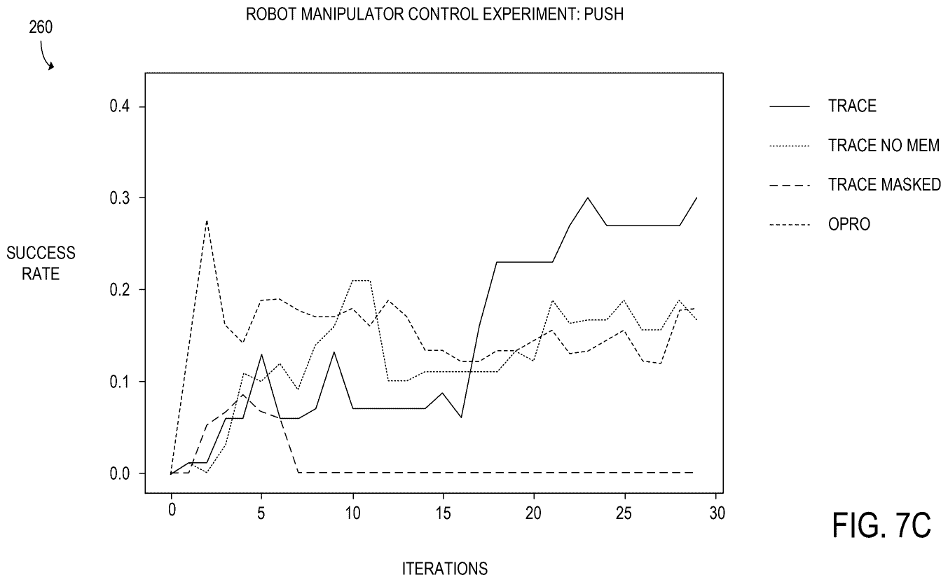

FIGS. 7A-7C show plots 240, 250, and 260 of the results of the robot manipulator control experiment for the reach, pick-place, and push tasks, respectively. As shown in the plots 240, 250, and 260, Trace had the highest success rate on the three tasks. OPRO was able to solve Reach at the start, but its performance degraded over the iterations. OPRO had similar performance as OptoPrime (without memory) in Push. In the ablation in which the execution trace of Trace was masked out, performance and stability significantly decreased.

Of the experiments discussed herein, the robot manipulator control experiment featured the most complex graph structures. The results of the robot manipulator control experiment demonstrate that Trace is able to learn sophisticated control logic in dozens of interactions. This control logic works not only on the training initial conditions but also on the held-out testing conditions.

Variants of Trace and OptoPrime are discussed below. Trace, as discussed above, can convert a computational workflow tuning problem into an OPTO problem. In addition, OptoPrime connects workflow tuning to the capabilities of an LLM. Techniques that guide the response generation of an LLM, such as Chain-of-Thought, Few-Shot Prompting, Tool Use, and Multi-Agent Workflows, can also be used with OptoPrime in some examples. A hybrid workflow of one or more LLMs and search algorithms may also be used with Trace to further generalize the workflow tuning capabilities of OptoPrime.

A specific propagator (MSP) is used in Trace. MSP maximally preserves information in a general computational graph. Alternatively, the propagator may be specialized for specific computations, e.g. to accommodate very large graphs. The memory module of OptoPrime may also be extended to include logic that predicts how a workflow will behave under counterfactual parameter settings, additionally or alternatively to storing previously visited parameter values.

The above discussion focuses on output feedback and context that can be compactly textualized. However, Trace may also be applied to computational workflows with rich non-textual contexts and output feedback. For example, the output feedback may include one or more images.

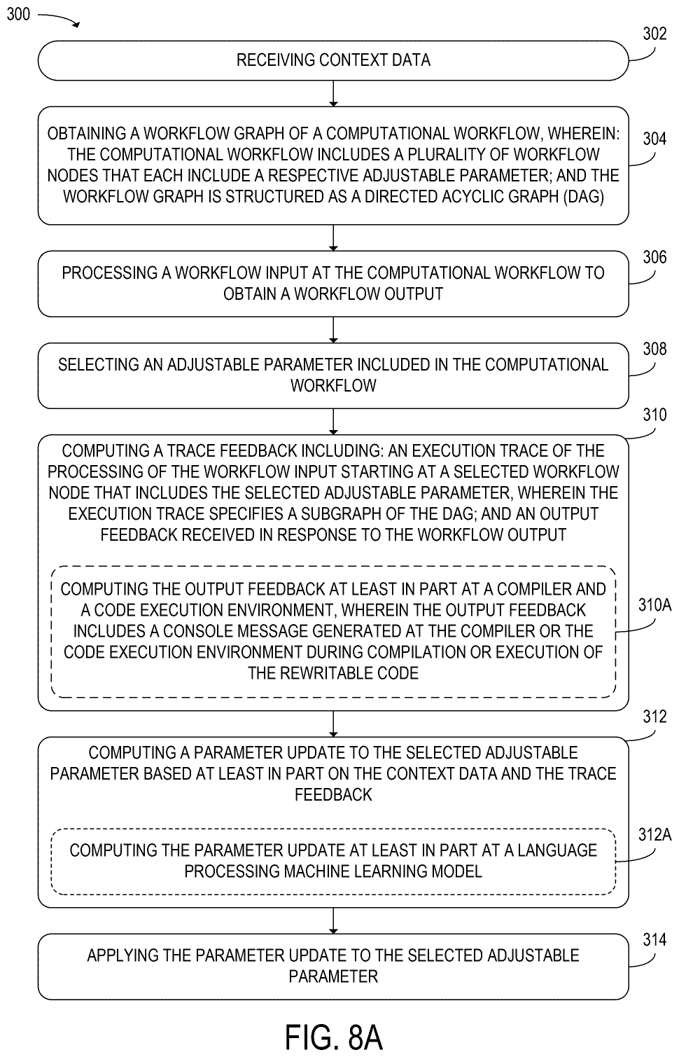

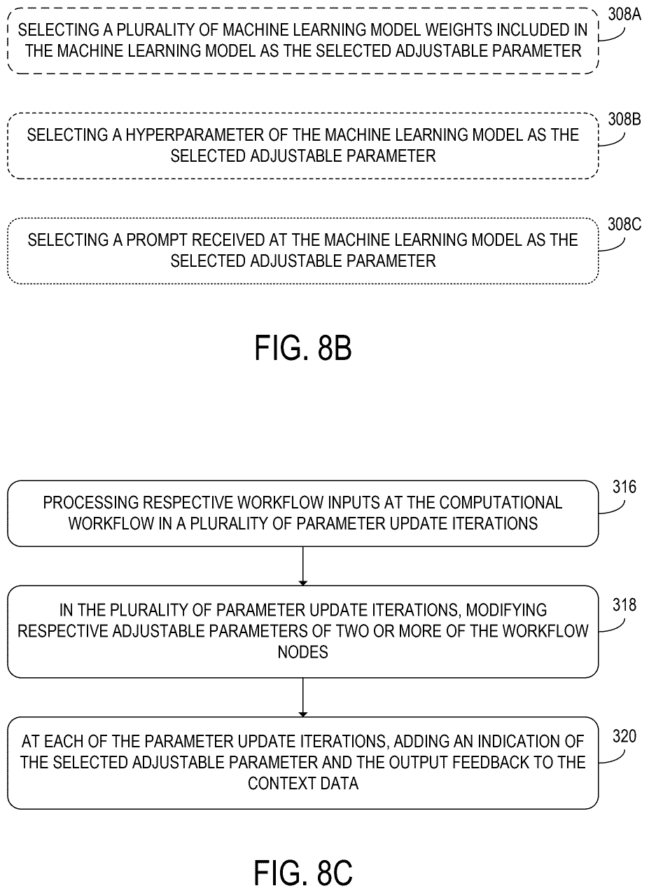

FIG. 8A shows a flowchart of a method 300 for use with a computing system to tune a computational workflow. At step 302, the method 300 includes receiving context data. The context data may be received as a text input. In some examples, the context data may specify an output objective of the computational workflow. For example, the context data may include an instruction to increase or decrease a numerical quantity included in a workflow output of the computational workflow. As another example, the context data may be a text instruction to follow output feedback.

At step 304, the method 300 further includes obtaining a workflow graph of the computational workflow. The computational workflow includes a plurality of workflow nodes that each include a respective adjustable parameter. The workflow graph is structured as a directed acyclic graph (DAG) that includes one or more directed edges connecting the workflow nodes. In some examples, the workflow graph may represent the computational workflow in a simplified form in which one or more sets of computational processes included in the computational workflow are bundled together into a single node.

At step 306, the method 300 further includes processing a workflow input at the computational workflow to obtain a workflow output.

At step 308, the method 300 further includes selecting an adjustable parameter included in the computational workflow. The selected adjustable parameter is selected from among the plurality of adjustable parameters included in the computational workflow.

FIG. 8B shows example steps that may be performed to select the adjustable parameter at step 308 in examples in which the plurality of workflow nodes include at least one machine learning model. At step 308A, step 308 may include selecting a plurality of machine learning model weights included in the machine learning model as the selected adjustable parameter. Thus, the machine learning model may be selected for additional training. At step 308B, step 308 may include selecting a hyperparameter of the machine learning model as the selected adjustable parameter. For example, the hyperparameter may be a temperature or a learning rate. At step 308C, step 308 may include selecting a prompt received at the machine learning model as the selected adjustable parameter. Thus, in such examples, tuning the computational workflow may include programmatic prompt engineering.

Returning to FIG. 8A, at step 310, the method 300 further includes computing a trace feedback. The trace feedback includes an execution trace of the processing of the workflow input starting at a selected workflow node that includes the selected adjustable parameter. The execution trace specifies a subgraph of the DAG. In some examples, the subgraph of the workflow graph is computed as a minimal subgraph between the selected adjustable parameter and the workflow output.

In addition to the execution trace, the trace feedback further includes an output feedback received in response to the workflow output. The output feedback is received from a feedback source that acts as a trace oracle of the computational workflow. For example, the output feedback may be computed as a value of an objective function that receives the workflow output as an input. As another example, the output feedback may include user feedback received via a GUI. As another example, the output feedback may be generated at a feedback machine learning model. Other types of computing processes may alternatively be used to obtain the output feedback. The output feedback may, for example, take the form of a numerical score or natural language feedback.

In some examples, the selected adjustable parameter may be rewritable code. In such examples, step 310 may include, at step 310A, computing the output feedback at least in part at a compiler and a code execution environment. In such examples, the output feedback may include a console message generated at the compiler or the code execution environment during compilation or execution of the rewritable code. The console message may, for example, indicate whether an error occurs during compilation and/or execution.

At step 312, the method further includes computing a parameter update to the selected adjustable parameter based at least in part on the context data and the trace feedback. For example, the parameter update may include a rewritten prompt, rewritten code, or an update to a machine learning model.

In some examples, the trace feedback may be a text feedback that specifies the execution trace and the output feedback in text form. In such examples, step 312 may include, at step 312A, computing the parameter update at least in part at a language processing machine learning model. The language processing machine learning model may be an LLM or an LMM.

At step 314, the method 300 further includes applying the parameter update to the selected adjustable parameter. Thus, the computational workflow is tuned using the parameter update. In examples in which the context data specifies an output objective, the parameter update may modify the selected adjustable parameter such that the computational workflow more closely satisfies the output objective.

FIG. 8C shows additional steps of the method 300 that may be performed in some examples. At step 316, the method 300 may further include processing respective workflow inputs at the computational workflow in a plurality of parameter update iterations. At step 318, in the plurality of parameter update iterations, the method 300 may further include modifying respective adjustable parameters of two or more of the workflow nodes. Thus, the computational workflow is iteratively tuned across multiple parameter update iterations. By adjusting multiple different adjustable parameters across the plurality of parameter update iterations, the method 300 includes performing end-to-end tuning of the computational workflow.

At step 320, the method 300 may further include, at each of the parameter update iterations, adding an indication of the selected adjustable parameter and the output feedback to the context data. An indication of the execution trace may also be added to the context data in some examples. The context data is accordingly updated to include records of previously visited parameter values. The indications of the selected adjustable parameter and the output feedback allow the prior tuning history of the computational workflow to inform the generation of the parameter update.

Using the systems and methods discussed above, workflow tuning may be performed for a wide variety of computational workflows. The systems and methods discussed above allow properties of backpropagation to be generalized to computational workflows that include non-differentiable parameters such as text prompts and code. The approaches discussed above also allow for end-to-end workflow tuning that includes modifications to multiple different parameters without requiring a developer to rewrite an updating loop for the workflow. In addition, the approaches discussed above may take advantage of the capabilities of LLMs and LMMs for tasks such as code generation and prompt engineering when computing parameter updates.

The methods and processes described herein are tied to a computing system of one or more computing devices. In particular, such methods and processes can be implemented as a computer-application program or service, an application-programming interface (API), a library, and/or other computer-program product.

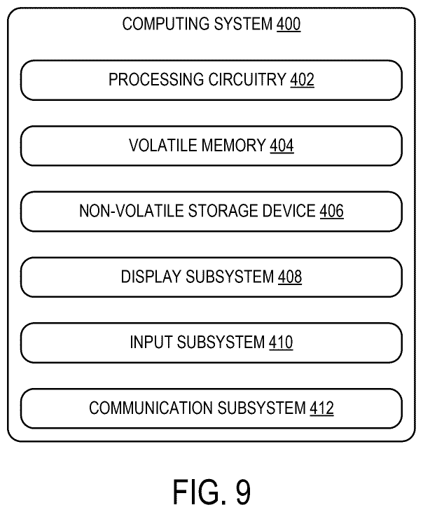

FIG. 9 schematically shows a non-limiting embodiment of a computing system 400 that can enact one or more of the methods and processes described above. Computing system 400 is shown in simplified form. Computing system 400 may embody the computing system 10 described above and illustrated in FIGS. 1A-1C. Components of computing system 400 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 400 includes processing circuitry 402, volatile memory 404, and a non-volatile storage device 406. Computing system 400 may optionally include a display subsystem 408, input subsystem 410, communication subsystem 412, and/or other components not shown in FIG. 9.

Processing circuitry 402 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 402 may be single-core or multi-core, and the instructions executed thereon may be configured for sequential, parallel, and/or distributed processing. Individual components of the processing circuitry 402 optionally may be distributed among two or more separate devices, which may be remotely located and/or configured for coordinated processing. For example, aspects of the computing system 400 disclosed herein may be virtualized and executed by remotely accessible, networked computing devices configured in a cloud-computing configuration. In such a case, these virtualized aspects are run on different physical logic processors of various different machines. These different physical logic processors of the different machines will be understood to be collectively encompassed by processing circuitry 402.

Non-volatile storage device 406 includes one or more physical devices configured to hold instructions executable by the processing circuitry to implement the methods and processes described herein. When such methods and processes are implemented, the state of non-volatile storage device 406 may be transformed—e.g., to hold different data.

Non-volatile storage device 406 may include physical devices that are removable and/or built in. Non-volatile storage device 406 may include optical memory, semiconductor memory, and/or magnetic memory, or other mass storage device technology. Non-volatile storage device 406 may include nonvolatile, dynamic, static, read/write, read-only, sequential-access, location-addressable, file-addressable, and/or content-addressable devices. It will be appreciated that non-volatile storage device 406 is configured to hold instructions even when power is cut to the non-volatile storage device 406.

Volatile memory 404 may include physical devices that include random access memory. Volatile memory 404 is typically utilized by processing circuitry 402 to temporarily store information during processing of software instructions. It will be appreciated that volatile memory 404 typically does not continue to store instructions when power is cut to the volatile memory 404.

Aspects of processing circuitry 402, volatile memory 404, and non-volatile storage device 406 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 400 typically implemented in software by a processor to perform a particular function using portions of volatile memory, which function involves transformative processing that specially configures the processor to perform the function. Thus, a module, program, or engine may be instantiated via processing circuitry 402 executing instructions held by non-volatile storage device 406, using portions of volatile memory 404. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 408 may be used to present a visual representation of data held by non-volatile storage device 406. The visual representation may take the form of a graphical user interface (GUI). As the herein described methods and processes change the data held by the non-volatile storage device 406, and thus transform the state of the non-volatile storage device 406, the state of display subsystem 408 may likewise be transformed to visually represent changes in the underlying data. Display subsystem 408 may include one or more display devices utilizing virtually any type of technology. Such display devices may be combined with processing circuitry 402, volatile memory 404, and/or non-volatile storage device 406 in a shared enclosure, or such display devices may be peripheral display devices.

When included, input subsystem 410 may comprise or interface with one or more user-input devices such as a keyboard, mouse, touch screen, camera, or microphone.

When included, communication subsystem 412 may be configured to communicatively couple various computing devices described herein with each other, and with other devices. Communication subsystem 412 may include wired and/or wireless communication devices compatible with one or more different communication protocols. As non-limiting examples, the communication subsystem 412 may be configured for communication via a wired or wireless local- or wide-area network, broadband cellular network, etc. In some embodiments, the communication subsystem 412 may allow computing system 400 to send and/or receive messages to and/or from other devices via a network such as the Internet.

The following paragraphs discuss several aspects of the present disclosure. According to one aspect of the present disclosure, a computing system is provided, including one or more processing devices configured to receive context data. The one or more processing devices are further configured to obtain a workflow graph of a computational workflow. The computational workflow includes a plurality of workflow nodes that each include a respective adjustable parameter. The workflow graph is structured as a directed acyclic graph (DAG). The one or more processing devices are further configured to process a workflow input at the computational workflow to obtain a workflow output. The one or more processing devices are further configured to select an adjustable parameter included in the computational workflow. The one or more processing devices are further configured to compute a trace feedback including an execution trace of the processing of the workflow input starting at a selected workflow node that includes the selected adjustable parameter, wherein the execution trace specifies a subgraph of the DAG. The trace feedback further includes an output feedback received in response to the workflow output. The one or more processing devices are further configured to compute a parameter update to the selected adjustable parameter based at least in part on the context data and the trace feedback. The one or more processing devices are further configured to apply the parameter update to the selected adjustable parameter. The above features may have the technical effect of updating the computational workflow in a flexible manner that generalizes backpropagation to be usable even with non-differentiable parameters. The above features may have the additional technical effect of programmatically computing the update without requiring a developer to manually rewrite an updating loop.

According to this aspect, the plurality of workflow nodes may include at least one machine learning model. The one or more processing devices may be configured to select a plurality of machine learning model weights included in the machine learning model as the selected adjustable parameter. The above features may have the technical effect of performing training at the machine learning model included in the computational workflow.

According to this aspect, the plurality of workflow nodes may include at least one machine learning model. The one or more processing devices may be configured to select a hyperparameter of the machine learning model as the selected adjustable parameter. The above features may have the technical effect of programmatically adjusting a hyperparameter of the machine learning model included in the computational workflow.

According to this aspect, the plurality of workflow nodes include at least one machine learning model. The one or more processing devices may be configured to select a prompt received at the machine learning model as the selected adjustable parameter. The above features may have the technical effect of performing programmatic prompt engineering at the machine learning model.

According to this aspect, the context data may specify an output objective of the computational workflow. The above feature may have the technical effect of specifying a target of the adjustment to the computational workflow.

According to this aspect, the context data may include an instruction to increase or decrease a numerical quantity included in the workflow output. The above feature may have the technical effect of steering the computational workflow toward outputs that have higher or lower values of the numerical quantity.

According to this aspect, the trace feedback may be a text feedback. The one or more processing devices may be configured to compute the parameter update at least in part at a language processing machine learning model. The above features may have the technical effect of utilizing natural language processing to compute the update to the computational workflow, such as by rewriting a prompt or incorporating user feedback.

According to this aspect, the selected adjustable parameter may be rewritable code. The one or more processing devices may be configured to compute the output feedback at least in part at a compiler and a code execution environment. The output feedback may include a console message generated at the compiler or the code execution environment during compilation or execution of the rewritable code. The above features may have the technical effect of programmatically modifying code in a manner that accounts for the results of compiling and/or executing that code.

According to this aspect, the one or more processing devices may be configured to process respective workflow inputs at the computational workflow in a plurality of parameter update iterations. In the plurality of parameter update iterations, the one or more processing devices may be configured to modify respective adjustable parameters of two or more of the workflow nodes. The above features may have the technical effect of executing an updating loop in which multiple parameters are updated.

According to this aspect, at each of the parameter update iterations, the one or more processing devices may be further configured to add an indication of the selected adjustable parameter and the output feedback to the context data. The above features may have the technical effect of tracking which parameters have been updated in order to inform later parameter update iterations.

According to this aspect, the one or more processing devices may be configured to compute the subgraph of the workflow graph as a minimal subgraph between the selected adjustable parameter and the workflow output. The above features may have the technical effect of reducing the number of nodes through which backpropagation is performed.

According to another aspect of the present disclosure, a method for use with a computing system is provided. The method includes receiving context data. The method further includes obtaining a workflow graph of a computational workflow. The computational workflow includes a plurality of workflow nodes that each include a respective adjustable parameter. The workflow graph is structured as a directed acyclic graph (DAG). The method further includes processing a workflow input at the computational workflow to obtain a workflow output. The method further includes selecting an adjustable parameter included in the computational workflow. The method further includes computing a trace feedback including an execution trace of the processing of the workflow input starting at a selected workflow node that includes the selected adjustable parameter. The execution trace specifies a subgraph of the DAG. The trace feedback further includes an output feedback received in response to the workflow output. The method further includes computing a parameter update to the selected adjustable parameter based at least in part on the context data and the trace feedback. The method further includes applying the parameter update to the selected adjustable parameter. The above features may have the technical effect of updating the computational workflow in a flexible manner that generalizes backpropagation to be usable even with non-differentiable parameters. The above features may have the additional technical effect of programmatically computing the update without requiring a developer to manually rewrite an updating loop.

According to this aspect, the plurality of workflow nodes may include at least one machine learning model. The method may further include selecting a plurality of machine learning model weights included in the machine learning model as the selected adjustable parameter. The above features may have the technical effect of performing training at the machine learning model included in the computational workflow.

According to this aspect, the plurality of workflow nodes may include at least one machine learning model. The method may further include selecting a hyperparameter of the machine learning model as the selected adjustable parameter. The above features may have the technical effect of programmatically adjusting a hyperparameter of the machine learning model included in the computational workflow.

According to this aspect, the plurality of workflow nodes may include at least one machine learning model. The method may further include selecting a prompt received at the machine learning model as the selected adjustable parameter. The above features may have the technical effect of performing programmatic prompt engineering at the machine learning model.

According to this aspect, the context data may specify an output objective of the computational workflow. The above feature may have the technical effect of specifying a target of the adjustment to the computational workflow.

According to this aspect, the trace feedback may be a text feedback. The method may further include computing the parameter update at least in part at a language processing machine learning model. The above features may have the technical effect of utilizing natural language processing to compute the update to the computational workflow, such as by rewriting a prompt or incorporating user feedback.

According to this aspect, the selected adjustable parameter may be rewritable code. The output feedback may be computed at least in part at a compiler and a code execution environment. The output feedback may include a console message generated at the compiler or the code execution environment during compilation or execution of the rewritable code. The above features may have the technical effect of programmatically modifying code in a manner that accounts for the results of compiling and/or executing that code.

According to this aspect, the method may further include processing respective workflow inputs at the computational workflow in a plurality of parameter update iterations. In the plurality of parameter update iterations, the method may further include modifying respective adjustable parameters of two or more of the workflow nodes. The above features may have the technical effect of executing an updating loop in which multiple parameters are updated.

According to another aspect of the present disclosure, a computing system is provided, including one or more processing devices configured to receive context data. The context data is a text input that specifies an output objective of a computational workflow. The one or more processing devices are further configured to obtain a workflow graph of the computational workflow. The computational workflow includes a plurality of workflow nodes that each include a respective adjustable parameter. The one or more processing devices are further configured to process a workflow input at the computational workflow to obtain a workflow output. The one or more processing devices are further configured to select an adjustable parameter included in the computational workflow. The one or more processing devices are further configured to compute a trace feedback including an execution trace of the processing of the workflow input starting at a selected workflow node that includes the selected adjustable parameter. The execution trace specifies a subgraph of the workflow graph. The trace feedback further includes an output feedback received in response to the workflow output. The trace feedback is a text feedback. The one or more processing devices are further configured to compute a parameter update to the selected adjustable parameter based at least in part on the context data and the trace feedback. The parameter update is computed at least in part at a language processing machine learning model. The one or more processing devices are further configured to apply the parameter update to the selected adjustable parameter. The above features may have the technical effect of updating the computational workflow in a flexible manner that generalizes backpropagation to be usable even with non-differentiable parameters. The above features may have the additional technical effect of programmatically computing the update without requiring a developer to manually rewrite an updating loop.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more processing devices configured to:
receive context data;
obtain a workflow graph of a computational workflow, wherein:
the computational workflow includes a plurality of workflow nodes that each include a respective adjustable parameter; and
the workflow graph is structured as a directed acyclic graph (DAG);
process a workflow input at the computational workflow to obtain a workflow output;
select an adjustable parameter included in the computational workflow;
compute a trace feedback including:
an execution trace of the processing of the workflow input starting at a selected workflow node that includes the selected adjustable parameter, wherein the execution trace specifies a subgraph of the DAG; and
an output feedback received in response to the workflow output;
compute a parameter update to the selected adjustable parameter based at least in part on the context data and the trace feedback; and
apply the parameter update to the selected adjustable parameter.

2. The computing system of claim 1, wherein:
the plurality of workflow nodes include at least one machine learning model; and
the one or more processing devices are configured to select a plurality of machine learning model weights included in the machine learning model as the selected adjustable parameter.

3. The computing system of claim 1, wherein:
the plurality of workflow nodes include at least one machine learning model; and
the one or more processing devices are configured to select a hyperparameter of the machine learning model as the selected adjustable parameter.

4. The computing system of claim 1, wherein:
the plurality of workflow nodes include at least one machine learning model; and
the one or more processing devices are configured to select a prompt received at the machine learning model as the selected adjustable parameter.

5. The computing system of claim 1, wherein the context data specifies an output objective of the computational workflow.

6. The computing system of claim 5, wherein the context data includes an instruction to increase or decrease a numerical quantity included in the workflow output.

7. The computing system of claim 1, wherein:
the trace feedback is a text feedback; and
the one or more processing devices are configured to compute the parameter update at least in part at a language processing machine learning model.

8. The computing system of claim 1, wherein:
the selected adjustable parameter is rewritable code;
the one or more processing devices are configured to compute the output feedback at least in part at a compiler and a code execution environment; and
the output feedback includes a console message generated at the compiler or the code execution environment during compilation or execution of the rewritable code.

9. The computing system of claim 1, wherein:
the one or more processing devices are configured to process respective workflow inputs at the computational workflow in a plurality of parameter update iterations; and
in the plurality of parameter update iterations, the one or more processing devices are configured to modify respective adjustable parameters of two or more of the workflow nodes.

10. The computing system of claim 9, wherein, at each of the parameter update iterations, the one or more processing devices are further configured to add an indication of the selected adjustable parameter and the output feedback to the context data.

11. The computing system of claim 1, wherein the one or more processing devices are configured to compute the subgraph of the workflow graph as a minimal subgraph between the selected adjustable parameter and the workflow output.

12. A method for use with a computing system, the method comprising:
receiving context data;
obtaining a workflow graph of a computational workflow, wherein:
the computational workflow includes a plurality of workflow nodes that each include a respective adjustable parameter; and
the workflow graph is structured as a directed acyclic graph (DAG);
processing a workflow input at the computational workflow to obtain a workflow output;
selecting an adjustable parameter included in the computational workflow;
computing a trace feedback including:
an execution trace of the processing of the workflow input starting at a selected workflow node that includes the selected adjustable parameter, wherein the execution trace specifies a subgraph of the DAG; and
an output feedback received in response to the workflow output;
computing a parameter update to the selected adjustable parameter based at least in part on the context data and the trace feedback; and
applying the parameter update to the selected adjustable parameter.

13. The method of claim 12, wherein:
the plurality of workflow nodes include at least one machine learning model; and
the method further comprises selecting a plurality of machine learning model weights included in the machine learning model as the selected adjustable parameter.

14. The method of claim 12, wherein:
the plurality of workflow nodes include at least one machine learning model; and
the method further comprises selecting a hyperparameter of the machine learning model as the selected adjustable parameter.

15. The method of claim 12, wherein:
the plurality of workflow nodes include at least one machine learning model; and
the method further comprises selecting a prompt received at the machine learning model as the selected adjustable parameter.

16. The method of claim 12, wherein the context data specifies an output objective of the computational workflow.

17. The method of claim 12, wherein:
the trace feedback is a text feedback; and
the method further comprises computing the parameter update at least in part at a language processing machine learning model.

18. The method of claim 12, wherein:
the selected adjustable parameter is rewritable code;
the output feedback is computed at least in part at a compiler and a code execution environment; and
the output feedback includes a console message generated at the compiler or the code execution environment during compilation or execution of the rewritable code.

19. The method of claim 12, wherein the method further comprises:
processing respective workflow inputs at the computational workflow in a plurality of parameter update iterations; and
in the plurality of parameter update iterations, modifying respective adjustable parameters of two or more of the workflow nodes.

20. A computing system comprising:
one or more processing devices configured to:
receive context data, wherein the context data is a text input that specifies an output objective of a computational workflow;
obtain a workflow graph of the computational workflow, wherein the computational workflow includes a plurality of workflow nodes that each include a respective adjustable parameter;
process a workflow input at the computational workflow to obtain a workflow output;
select an adjustable parameter included in the computational workflow;
compute a trace feedback including:
an execution trace of the processing of the workflow input starting at a selected workflow node that includes the selected adjustable parameter, wherein the execution trace specifies a subgraph of the workflow graph; and
an output feedback received in response to the workflow output,
wherein the trace feedback is a text feedback;
compute a parameter update to the selected adjustable parameter based at least in part on the context data and the trace feedback, wherein the parameter update is computed at least in part at a language processing machine learning model; and
apply the parameter update to the selected adjustable parameter.
